(19) United States
(12) Patent Application Publication
(10) Pub. No.: US 2026/0120551 A1
(43) Pub. Date: Apr. 30, 2026

(54) COLLISION WARNING DEVICE, COLLISION WARNING METHOD, AND COLLISION WARNING PROGRAM

(71) Applicant: NEC Corporation, Tokyo (JP)

(72) Inventors: Yuki KOBAYASHI, Tokyo (JP); Seiya SHIBATA, Tokyo (JP); Mizuho KATAYAMA, Tokyo (JP); Toshikazu NAKAJIMA, Tokyo (JP); Yushi NIWA, Tokyo (JP)

(73) Assignee: NEC Corporation, Tokyo (JP)

(21) Appl. No.: 19/353,871

(22) Filed: Oct. 9, 2025

(30) Foreign Application Priority Data
Oct. 30, 2024 (JP) 2024-190229

(51) Int. Cl. G08B 21/02; G06V 20/52; G08B 31/00

(52) U.S. Cl. CPC G08B 21/02; G06V 20/52; G08B 31/00; G06V 2201/08

(57) ABSTRACT

The collision warning device includes an object behavior prediction unit that predicts behavior of an object based on object behavior history information indicating a behavior history of the object detected from input images and work instruction information indicating a work instruction related to the object, and a collision prediction unit that predicts a collision between objects based on a behavior prediction result by the object behavior prediction unit and outputs collision warning information based on a collision prediction result.

This application is based upon and claims the benefit of priority from the prior Japanese Patent Application No. 2024-190229, filed Oct. 30, 2024, the entire contents of which are incorporated herein by reference.

### BACKGROUND OF INVENTION

### Field of the Invention

The present disclosure relates to a collision warning device, a collision warning method, and a collision warning program.

### Description of the Related Art

As a technology related to collision warning, for example, Patent Literature 1 discloses a technique for predicting whether contact occurs between vehicles or between a vehicle and a pedestrian.

A recognition unit of a server device described in Patent Literature 1 recognizes the position of a vehicle from image data. A behavior prediction unit of the server device predicts the behavior of the recognized vehicle using a trained model such as deep learning. The behavior prediction unit then predicts whether contact occurs between vehicles or between a vehicle and a pedestrian.
[Patent Literature 1] Japanese Patent Application Publication No. 2023-081288

### SUMMARY OF INVENTION

Patent Literature 1 discloses a technique for predicting the movement vector of a vehicle through behavior prediction, and predicting a high possibility of contact when the travel directions are opposite. However, a specific method for behavior prediction is not shown. In general, it is difficult to accurately predict changes in the travel direction or relatively distant future movements of a vehicle based on image data. Therefore, it is also difficult to predict the possibility of collision due to changes in travel direction. Thus, the technique described in Patent Literature 1 has room for improvement.

The present disclosure has been made in view of these issues. One of the objectives of the present disclosure is to provide a collision warning device, a collision warning method, and a collision warning program that can improve the prediction accuracy.

A preferred aspect of the learning collision warning device includes an object behavior prediction unit that predicts behavior of an object based on object behavior history information indicating a behavior history of the object detected from input images and work instruction information indicating a work instruction related to the object, and a collision prediction unit that predicts a collision between objects based on a behavior prediction result by the object behavior prediction unit and outputs collision warning information based on a collision prediction result.

A preferred aspect of the collision warning method performed by a computer includes predicting behavior of an object based on object behavior history information indicating a behavior history of the object detected from input images and work instruction information indicating a work instruction related to the object, predicting a collision between objects based on a behavior prediction result and outputting collision warning information based on a collision prediction result.

A preferred aspect of the collision warning program causes a computer to execute an object behavior prediction process to predict behavior of an object based on object behavior history information indicating a behavior history of the object detected from input images and work instruction information indicating a work instruction related to the object, and a collision prediction process to predict a collision between objects based on a behavior prediction result by the object behavior prediction process and to output collision warning information based on a collision prediction result.

According to the present disclosure, it is possible to improve the prediction accuracy.

### BRIEF DESCRIPTION OF THE DRAWINGS

FIG. 1 It depicts a block diagram illustrating a collision warning device.

FIG. 2 It depicts an explanatory diagram illustrating an example of a situation in a warehouse.

FIG. 3A It depicts an explanatory diagram illustrating an example of object detection result information.

FIG. 3B It depicts an explanatory diagram illustrating an image visualizing the object detection result

FIG. 4 It depicts an explanatory diagram illustrating an example of object behavior history information.

FIG. 5 It depicts an explanatory diagram illustrating an example of position history of an object.

FIG. 6 It depicts an explanatory diagram illustrating an example of updated object behavior history information.

FIG. 7 It depicts an explanatory diagram illustrating an example of work instruction information.

FIG. 8A It depicts an explanatory diagram illustrating an example of object behavior prediction.

FIG. 8B It depicts an explanatory diagram illustrating an example of the method for object behavior prediction.

FIG. 8C It depicts an explanatory diagram illustrating an example of the method for object behavior prediction.

FIG. 9 It depicts a flowchart illustrating an operation of the collision warning device.

FIG. 10 It depicts a block diagram illustrating a hardware configuration of a computer that realizes the collision warning device.

FIG. 11 It depicts a block diagram illustrating a main part of the collision warning device.

### DESCRIPTION OF THE PREFERRED EMBODIMENTS

To prevent collisions between forklifts running in a warehouse, a method of warning forklifts using surveillance cameras installed in the warehouse has been proposed.

In Patent Literature 1, a method is disclosed in which image data obtained from cameras installed in parking lots or warehouses is analyzed, a movement vector of a vehicle is predicted, and contact prediction is performed. That is, a plurality of vehicles and pedestrians are recognized from image data, and their future behaviors are predicted to determine the possibility of contact. However, specific methods for behavior prediction are not specified. In addition, in contact prediction, it is determined that the possibility of contact is high when travel directions are opposite.

Document 2 (Japanese Patent Application Publication No. 2024-7857) discloses a method for accurately detecting the behavior of a moving object from an image captured from above. Document 3 (WO 2015/001677) discloses a method for reducing the occurrence of collision accidents at intersections and the like by recognizing the presence of a moving body and notifying it. Document 4 (Japanese Patent Application Publication No. 2019-207653) discloses a method for detecting behavior based on the travel direction of a vehicle and the amount of movement per unit time.

However, in these general methods, it is difficult to accurately predict in which direction a vehicle will turn. Therefore, it is difficult to predict whether forklifts moving at high speed in a narrow warehouse can safely pass each other or may suddenly turn and collide.

One problem is that it is difficult to predict relatively distant future movements from past image data obtained from a camera. This is because it is difficult to predict the final destination of the forklift.

One of the objectives of the present disclosure is to provide a collision warning device capable of solving the problem of difficulty in predicting relatively distant future movements. The collision warning device of the present disclosure corrects the predicted route by considering the destination of the forklift based on information in a work instruction database for forklift operators. With such a configuration, the collision warning device of the present disclosure can improve the accuracy of route prediction and, as a result, also improve the accuracy of collision prediction. Therefore, the collision warning device of the present disclosure can enhance safety in the environment in which it is applied.

Hereinafter, example embodiments of the present disclosure will be explained with reference to the drawings. In each drawing, the same or relevant elements are denoted by the same reference numerals, and redundant descriptions may be omitted as needed for clarity of explanation. Unless otherwise specified, predetermined values such as threshold values are stored in advance in a storage device accessible by the device using the value. Unless otherwise specified, a storage unit is composed of one or more arbitrary numbers of storage devices.

### Example Embodiment 1

### [Explanation of Configuration]

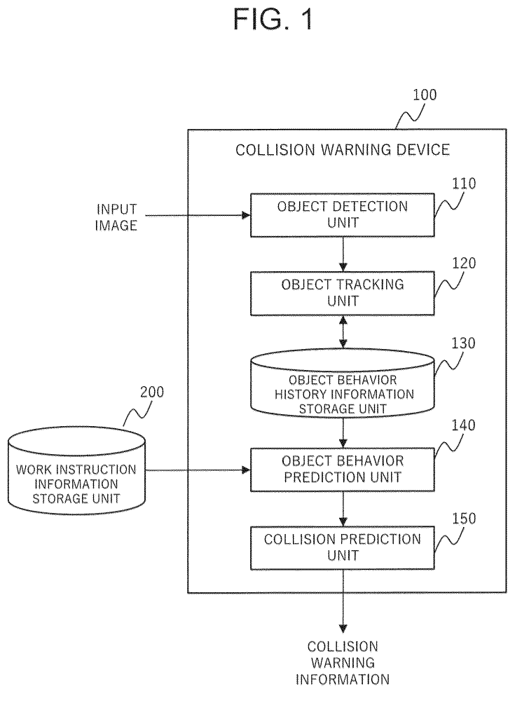

The collision warning device of the present example embodiment will be explained. FIG. 1 is a block diagram illustrating a collision warning device. A collision warning device 100 of the present example embodiment includes an object detection unit 110, an object tracking unit 120, an object behavior history information storage unit 130, an object behavior prediction unit 140, and a collision prediction unit 150.

The collision warning device 100 inputs a target image to be processed. Hereinafter, an image input to the collision warning device 100 is also referred to as an input image. The collision warning device 100 may input, for example, an image captured by an imaging device such as a surveillance camera as the input image. The collision warning device 100 may input, as the input image, each image (for example, a plurality of frame images constituting a moving image) continuously output from an external device such as a surveillance camera at a predetermined frame rate.

The object detection unit 110 includes a function to detect objects from an input image. For example, the object detection unit 110 analyzes the input image and detects objects and their positions in the image. The object detection unit 110 outputs object detection result information indicating the object detection result to the object tracking unit 120. The object detection unit 110 may also store the object detection result information in the object behavior history information storage unit 130.

The processing executed by the object detection unit 110 is generally referred to as object detection. This processing can be achieved using a known technique such as YoloX, for example, as disclosed in Document 5 (“Megvii-BaseDetection/YOLOX”, [online], [searched on Oct. 16, 2024], Internet, URL: https://github.com/Megvii-BaseDetection/YOLOX).

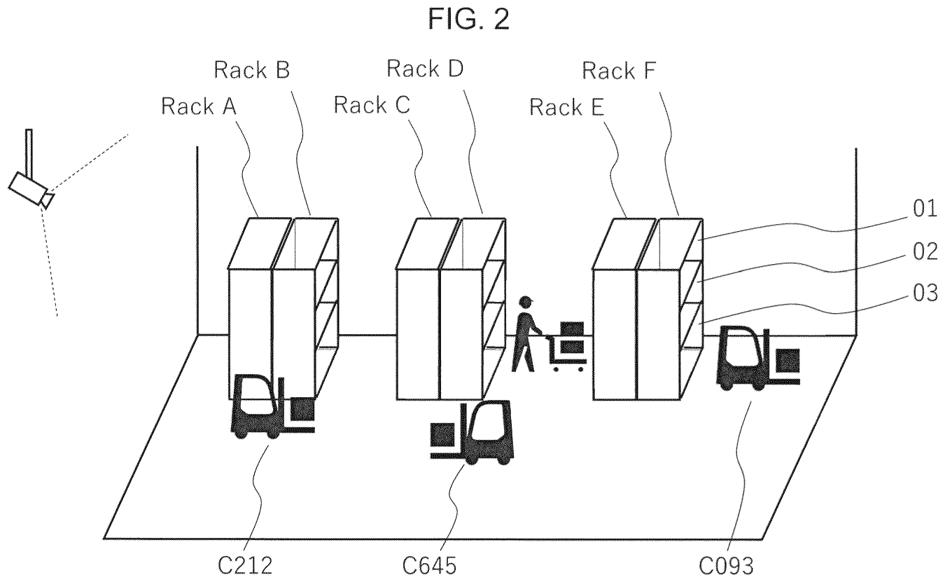

FIG. 2 is an explanatory diagram illustrating an example of a situation in a warehouse. In FIG. 2, a situation in which three forklifts, one person (for example, a worker), and three-level racks A to F exist in the warehouse is illustrated. A camera is installed near the ceiling of the warehouse, and this camera captures the situation inside the warehouse. The captured image is input to the collision warning device 100 as an input image. When a moving image is captured, a plurality of frame images constituting the moving image are sequentially input to the collision warning device 100 as input images. In the present example embodiment, the case where the vehicle is a forklift is assumed and explained. However, the type of vehicle to which the collision warning device 100 is applicable is not limited to forklifts.

Each forklift illustrated in FIG. 2 is assigned a vehicle number on its side. The vehicle numbers assigned to the forklifts are C212, C645, and C093. In FIG. 2, an example is illustrated in which the vehicle number is directly painted on the side of the vehicle (that is, the forklift), but the method of identifying the vehicle is not limited to this. For example, each vehicle may be identified using other means such as a license plate or a barcode.

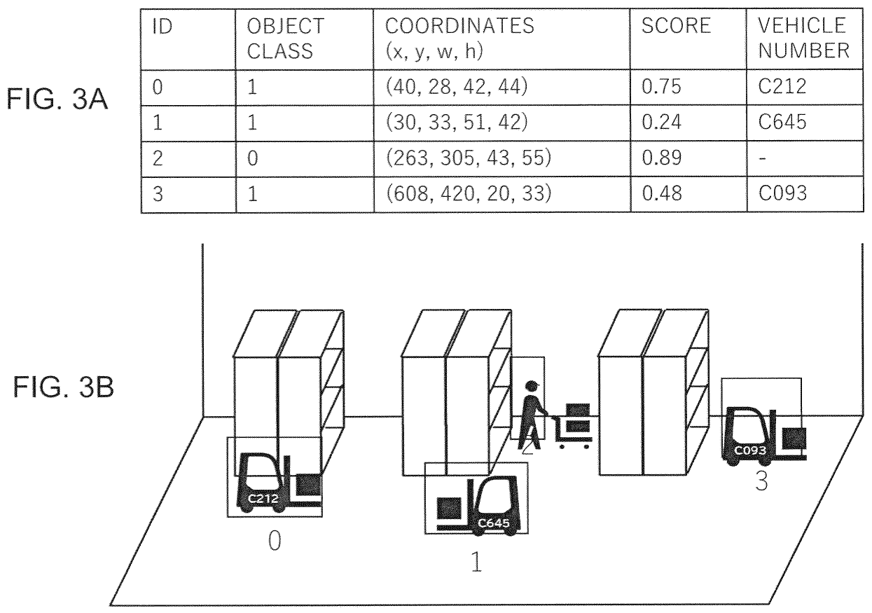

FIG. 3A is an explanatory diagram illustrating an example of object detection result information.

FIG. 3A illustrates object detection result information in a case where four objects are detected from one input image (for example, one frame image). This object detection result information includes an ID for identifying the detected object, an object class indicating the type of the object, coordinates indicating the position of the object on the image, a score indicating the confidence level of the object detection, and a vehicle number associated to the object.

In the object detection result information of FIG. 3A, object class: 0 represents a human, and object class: 1 represents a forklift. Coordinates are expressed by x coordinate, y coordinate, width (w), and height (h). The score is represented by a real number between 0 and 1, where a value closer to 1 indicates higher reliability of the detection result. The vehicle number is the number detected from the vehicle body as described above.

The object detection unit 110 may acquire the vehicle number by applying character recognition (OCR) processing to the image region of the detected object, for example. However, the method of acquiring the vehicle number is not limited to this. For example, by extending the object detection processing, the object detection unit 110 may be configured to directly detect and output the vehicle number. Furthermore, by further extending the object detection processing, the object detection unit 110 may be configured to detect not only the forklift but also a license plate region or a vehicle number region, and apply character recognition processing to the detected region.

Note that depending on the angle at which the forklift is captured, the vehicle number may not appear in the image. In such a case, there may be a frame image in which the vehicle number cannot be detected. However, these pieces of information can be complemented by the object tracking processing described later, so it is not necessary to detect the vehicle number in all frame images.

FIG. 3B illustrates an image visualizing the object detection result. In FIG. 3B, a rectangular region including a forklift with vehicle number C212 is displayed in association with object detection result ID: 0. A rectangular region including a forklift with vehicle number C645 is displayed in association with object detection result ID: 1. A rectangular region including a human (worker) is displayed in association with object detection result ID: 2. A rectangular region including a forklift with vehicle number C093 is displayed in association with object ID: 3.

The object tracking unit 120 includes a function to track the behavior of an object. For example, the object tracking unit 120 performs object tracking processing to track the behavior of the object based on the object detection result of one input image (for example, an n-th frame image) and the object detection result of a past input image obtained before the one input image (for example, an (n−1)-th frame image). The object tracking unit 120 updates the object behavior history information indicating the behavior history of the object based on the object tracking result. When no existing object behavior history information is present, the object tracking unit 120 newly generates the object behavior history information.

The object tracking unit 120 may also perform object tracking processing based on the object detection result of a new input image (for example, an n-th frame image) and the object behavior history information generated based on past multiple input images (for example, the (n−1)-th and (n−2)-th frame images).

In the present example embodiment, the object behavior history information storage unit 130 stores object detection result information of past input images. For example, the object detection unit 110 directly stores the object detection result information in the object behavior history information storage unit 130. Alternatively, for example, the object tracking unit 120 stores the object detection result information output from the object detection unit 110 in the object behavior history information storage unit 130. In addition, in the present example embodiment, the object behavior history information storage unit 130 stores the object behavior history information.

The object tracking unit 120 identifies the association between an object detected in a new input image and an object detected in a past input image, and updates the movement history of the object based on the identification result. That is, the object tracking unit 120 updates the object behavior history information stored in the object behavior history information storage unit 130 (that is, the object behavior history information based on past input images acquired before the new input image).

As described above, when the vehicle number of an object is identified from identification information such as a number plate or barcode of the forklift in the input image, the object tracking unit 120 stores the object behavior history information including the vehicle number in the object behavior history information storage unit 130. Even when the vehicle number of the object cannot be identified from the input image, the object tracking unit 120 can identify the vehicle number by associating the object with a previously detected object from past input images whose vehicle number has been identified. Accordingly, even when the vehicle number of the object cannot be identified from the input image in the object detection processing, the collision warning device 100 can complement such information through the object tracking processing.

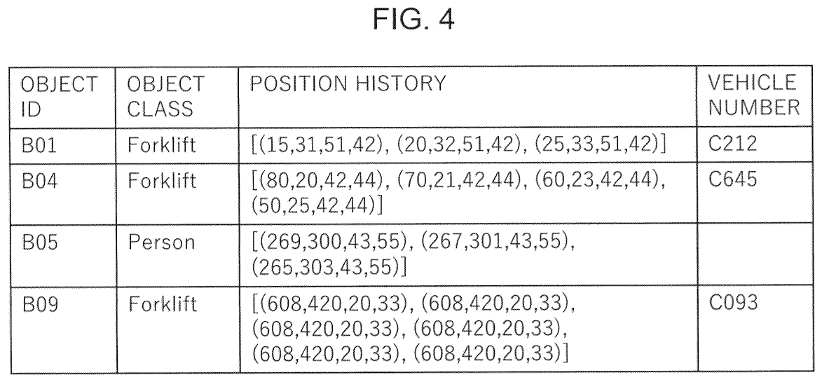

FIG. 4 illustrates an example of object behavior history information. The object behavior history information shown in FIG. 4 includes four objects identified by object IDs: B01, B04, B05, and B09. In the object behavior history information, each object ID is associated to an object class, a position history indicating the past detected positions of the object, and a vehicle number related to the object.

The object tracking unit 120 determines, for example, for each object included in the object detection result information of a new input image, a corresponding object from the object behavior history information.

When a new object is detected by the object detection unit 110, the object tracking unit 120 assigns a new object ID to the object. When an object is no longer detected from input images, the object ID associated to the object becomes unnecessary. The object tracking unit 120 may delete information associated to an unnecessary object ID after a predetermined period has elapsed since the object was last detected. In this case, the object IDs may become discontinuous. Also in this case, the number of position histories may differ between objects.

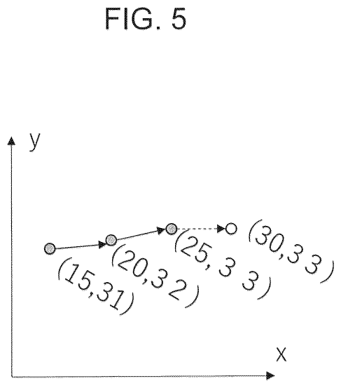

FIG. 5 is an explanatory diagram illustrating an example of a position history of an object. FIG. 5 illustrates the position history of object ID: B01. In the object behavior history information shown in FIG. 4, the object with object ID: B01 has a behavior history with position history: (x, y)=(15, 31), (20, 32), (25, 33). On the other hand, in the object detection result information shown in FIG. 3A, the object with ID: 1 exists at coordinate (x, y)=(30, 33). The object tracking unit 120 determines, based on the position history in the object behavior history information, that the object with ID: 1 in the object detection result information is the object related to object ID: B01 in the object behavior history information. As a result, FIG. 5 shows the position history of object ID: B01 as (x, y)=(15, 31), (20, 32), (25, 33), (30, 33). Likewise, the object tracking unit 120 determines, based on the position history in the object behavior history information, that the objects with IDs: 0, 2, and 3 in the object detection result information are respectively the objects related to object IDs: B04, B05, and B09 in the object behavior history information.

The method of associating objects included in the object detection result information of a new input image with objects included in the object behavior history information is not limited to the above-described method. For example, the object tracking unit 120 can improve the association accuracy by using information such as a vehicle number, size (width and height) of the object, or color information.

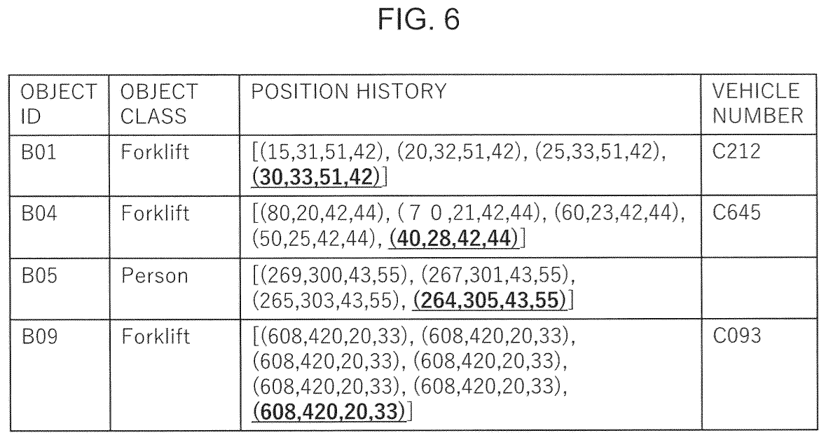

FIG. 6 is an explanatory diagram illustrating an example of updated object behavior history information. In the updated object behavior history information shown in FIG. 6, a position history is added for each object for which an association has been determined. Specifically, for object ID: B01, information indicating coordinate (30, 33, 51, 42) is newly added to the position history.

The object behavior prediction unit 140 includes a function to predict the behavior of an object based on object behavior history information indicating a behavior history of an object detected from input images and work instruction information indicating a work instruction related to the object. The object behavior prediction unit 140 predicts behavior such as the movement direction of the object and outputs a prediction result as predicted object behavior information to the collision prediction unit 150.

The object behavior prediction unit 140 predicts the behavior of an object based on, for example, the object behavior history information and destination-related information included in the work instruction information that enables identifying the destination of the object. When the destination-related information cannot be obtained, the object behavior prediction unit 140 predicts the behavior of the object based on the object behavior history information. An example of when the destination-related information cannot be obtained is when the vehicle number of the object has not been identified. In this case, since the object is not identified, the destination of the object also cannot be determined.

The work instruction information is stored in a work instruction information storage unit 200. The object behavior prediction unit 140 inputs the work instruction information from the work instruction information storage unit 200. The work instruction information storage unit 200 may be provided within the collision warning device 100 or in an external device different from the collision warning device 100.

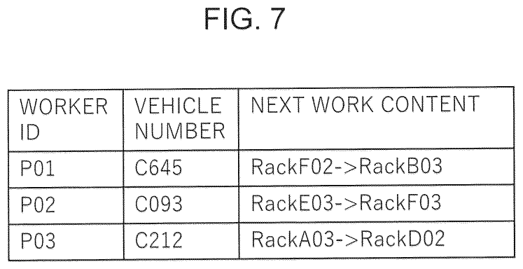

FIG. 7 is an explanatory diagram illustrating an example of work instruction information. The work instruction information includes a worker ID for identifying a worker, a vehicle number of the vehicle used by the worker, and a next work content. In the first row of the work instruction information shown in FIG. 7, a work instruction is shown indicating that a worker with worker ID: P01 uses a forklift with vehicle number: C645 to transport cargo from rack F02 to rack B03. Rack F02 refers to the second level from the top of rack F. However, the format of information indicating locations such as destinations is not limited to this. For example, the location information may be in a format that allows specifying directions within a rack by assigning numbers to vertical, width, and depth directions. Note that the work instruction information shown in FIG. 7 only includes information relevant to the object behavior prediction unit 140. The work instruction information may include additional information beyond what is shown in FIG. 7. For example, it may include not only the next work content but also the subsequent work content.

The object behavior prediction unit 140 may obtain destination-related information from the work instruction information that enables identifying the destination of the vehicle related to a vehicle number. For example, in the example shown in FIG. 7, based on the next work content corresponding to vehicle number: C645, the destination of vehicle number: C645 is identified as rack B03. Similarly, based on the next work content corresponding to vehicle number: C212, the destination of vehicle number: C212 is identified as rack D02. In this way, in the example shown in FIG. 7, the next work content corresponds to the destination-related information.

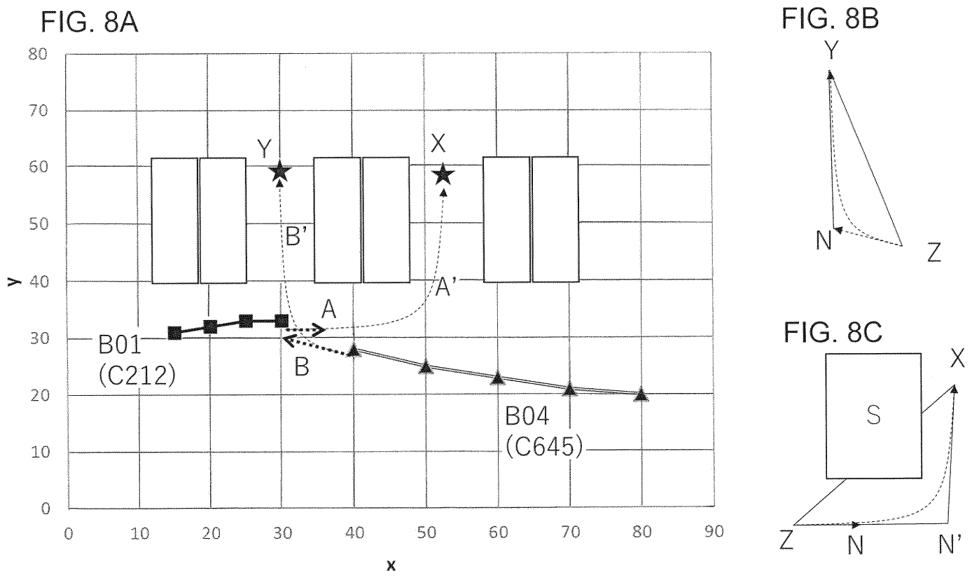

FIG. 8A is an explanatory diagram illustrating an example of object behavior prediction. FIG. 8A shows an example focusing on object ID: B01 (vehicle number C212) and object ID: B04 (vehicle number C645). In the example of FIG. 8A, the object with ID: B01 moves to the right, and the object with ID: B04 moves to the left. In FIG. 8A, the destination of object ID: B01, that is, rack D02, is indicated by X. The destination of object ID: B04, that is, rack B03, is indicated by Y.

In FIG. 8A, the predicted routes of object ID: B01 and object ID: B04 (corresponding to movement vectors as described later) are indicated as vector A and vector B, respectively.

The object behavior prediction unit 140 may calculate a predicted route of the object based on the object behavior history information. Hereinafter, the predicted route of the object calculated based on the object behavior history information is also referred to as the movement vector of the object. The movement vector of the object is calculated, for example, from the immediately preceding behavior of the object (that is, the movement history). For example, the object behavior prediction unit 140 may calculate the movement vector based on the movement history of the past one frame. However, the method for calculating the movement vector applicable to the object behavior prediction unit 140 is not limited to this. For example, the object behavior prediction unit 140 may calculate the movement vector based on the movement history of past two or more frames. Furthermore, the object behavior prediction unit 140 may apply a predetermined coefficient to the length of the vector calculated based on the movement history to scale the length of the vector.

When behavior prediction and collision prediction are performed only using the movement vector A of object ID: B01 and the movement vector B of object ID: B04, it is predicted that the two objects pass each other without collision because the two vectors do not intersect. However, when the destination of object ID: B04 is at coordinate Y, the object ID: B04 is highly likely to take route B′ toward Y. Similarly, when the destination of object ID: B01 is at coordinate X, the object ID: B01 is highly likely to take route A′ toward X. In this case, since route A′ of object ID: B01 and route B′ of object ID: B04 intersect, it is determined that a collision may occur.

Therefore, in the present example embodiment, the object behavior prediction unit 140 predicts the behavior of the object based on the object behavior history information and destination-related information included in the work instruction information. Specifically, the object behavior prediction unit 140 predicts the behavior of the object based on the predicted route of the object (that is, the movement vector) calculated from the object behavior history information and the positional relationship between the current position of the object and its destination.

FIG. 8B illustrates an example of the method for object behavior prediction. In the example shown in FIG. 8B, the object behavior prediction unit 140 calculates a curve connecting the start point and the destination based on a line segment defined by the start and end points of the movement vector and a line segment defined by the end point and the destination, and adopts the curve as the final predicted route. Note that the start point of the movement vector corresponds to the current position of the object.

In FIG. 8B, Z represents the current position of the object, line segment ZN represents the movement vector, and Y represents the destination. By creating a Bezier curve based on line segment ZN and line segment NY, the dashed curve ZY shown in FIG. 8B is obtained. The object behavior prediction unit 140 generates object behavior prediction information by adopting the dashed curve ZY as the final predicted route. Note that the object behavior prediction unit 140 may use other methods such as spline curves in addition to Bezier curves to generate the object behavior prediction information.

When there is an obstacle such as a rack between the current position of the object and the destination, the object behavior prediction unit 140 may predict a route that avoids the obstacle. That is, when an obstacle exists between the start point of the movement vector and the destination of the object, the object behavior prediction unit 140 calculates a curve connecting the start point and the destination while avoiding the obstacle and generates the object behavior prediction information by adopting the curve as the final predicted route. Specifically, as shown in FIG. 8C, when an obstacle S exists between Z and X, the object behavior prediction unit 140 defines a new point N′ on the extension of ZN and calculates a curve based on line segments ZN′ and N′X.

In this way, the object behavior prediction unit 140 can predict the behavior of the object by taking into account the destination of the object. In other words, the object behavior prediction unit 140 can modify the predicted route of the object (that is, the movement vector) calculated based on the object behavior history information in such a way as to consider the destination of the object. As a result, the object behavior prediction unit 140 can improve the accuracy of object behavior prediction.

The collision prediction unit 150 includes a function to predict collisions between objects based on the behavior prediction result by the object behavior prediction unit 140 and to output collision warning information based on the collision prediction result. For example, the collision prediction unit 150 may identify a combination of objects for which a collision is predicted based on the predicted object behavior information and output the identification result as the collision warning information.

The collision prediction unit 150 predicts that objects with intersecting predicted routes may collide. In the example of FIG. 8A, the predicted route B′ of object ID: B04 and predicted route A′ of object ID: B01, calculated using the method of FIG. 8B, intersect. Therefore, the collision prediction unit 150 predicts that object ID: B04 and object ID: B01 are objects that may collide. The collision prediction unit 150 may also predict a collision when predicted routes of different objects overlap.

The collision prediction unit 150 includes a function to output collision warning information based on the prediction result. The format or method of outputting the collision warning information may vary. For example, the collision prediction unit 150 may output collision warning information to cause a speaker installed in the warehouse where forklifts operate to emit a sound or buzzer. Alternatively, the collision prediction unit 150 may output collision warning information to cause a speaker installed on a predicted-to-collide forklift to emit a sound or buzzer. Furthermore, the collision prediction unit 150 may output collision warning information to instruct a brake on a predicted-to-collide forklift. However, the format and method of outputting collision warning information by the collision prediction unit 150 are not limited to the above.

The collision prediction unit 150 may predict not only collisions between forklifts but also collisions between a forklift and a person.

### [Explanation of Operation]

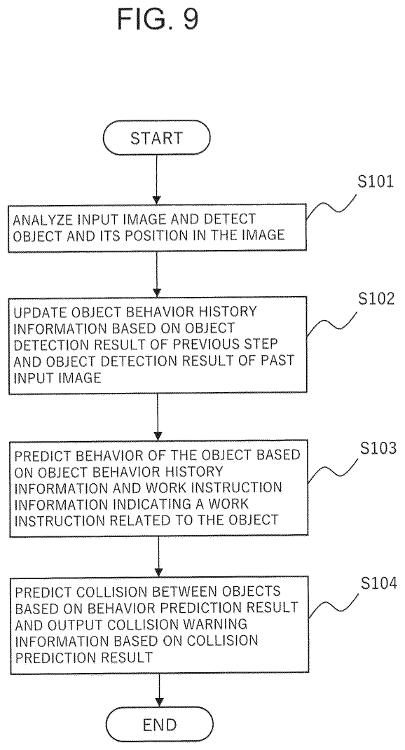

Next, the overall operation of the present example embodiment will be explained in detail with reference to the flowchart of FIG. 9. FIG. 9 is a flowchart illustrating the operation of the collision warning device.

The object detection unit 110 detects an object from an input image (step S101). For example, the object detection unit 110 analyzes the input image from a camera and detects an object and its position in the image.

Next, the object tracking unit 120 updates the object behavior history information based on the object detection result of one input image and the object detection result of a past input image obtained before the one input image (step S102). For example, the object tracking unit 120 uses the object behavior history information to identify an object detected in step S101 and add it to the corresponding object behavior history information. In addition, when the vehicle number of the object can be identified, the object tracking unit 120 also adds that information.

Next, the object behavior prediction unit 140 predicts the behavior of the object based on the object behavior history information indicating the behavior history of the object and the work instruction information indicating a work instruction related to the object (step S103). For example, the object behavior prediction unit 140 predicts the behavior such as the movement direction of the object using the predicted route (movement vector) of the object calculated based on the object behavior history information, and destination-related information in the work instruction information corresponding to the vehicle number when the vehicle number has been identified.

Next, the collision prediction unit 150 predicts a collision between objects based on the behavior prediction result and outputs collision warning information based on the collision prediction result (step S104). For example, the collision prediction unit 150 determines a combination of objects for which a collision is predicted using the predicted object behavior information obtained in step S103, and outputs the result as the collision warning information.

The operational example shown in FIG. 9 does not limit the operation of the collision warning device 100 according to the present disclosure. For example, in step S103, when destination-related information cannot be obtained, the object behavior prediction unit 140 may predict the behavior of the object based on the object behavior history information indicating the behavior history of the object.

### Explanation of Effects

Next, the effects of the present example embodiment will be explained. In the present example embodiment, the object behavior prediction unit 140 predicts the behavior of the object based on the object behavior history information indicating the behavior history of the object detected from the input image and the work instruction information indicating a work instruction related to the object. Specifically, the work instruction information includes destination-related information that enables identifying the destination of the object. The object behavior prediction unit 140 predicts the behavior of the object based on the predicted route (that is, movement vector) calculated from the object behavior history information and the positional relationship between the current position and the destination of the object. With such a configuration, the collision warning device 100 can predict the behavior of the object in such a way as to consider the destination of the object. In other words, the collision warning device 100 can modify the predicted route of the object calculated from the object behavior history information in such a way as to consider the destination of the object. As a result, the collision warning device 100 can improve the accuracy of object behavior prediction.

For example, assume that the collision warning device 100 is utilized to prevent collisions between forklifts traveling within a warehouse. In this case, the collision warning device 100 modifies the predicted route (that is, movement vector) of the object calculated based on the object behavior history information by considering the location of the forklift's destination obtained from the work instruction information provided to the forklift operator. With such a configuration, the collision warning device 100 can improve the accuracy of forklift route prediction. That is, movement vector information of the forklift calculated by analyzing past input images can only accurately predict recent behavior. In contrast, the collision warning device 100 of the present example embodiment can identify the destination of the forklift by referring to the work instruction information and, by considering this, predict even relatively distant future movement of the forklift more accurately.

In addition, in the present example embodiment, the collision prediction unit 150 predicts a collision between objects based on the object behavior prediction result by the object behavior prediction unit 140 and outputs collision warning information based on the collision prediction result. Specifically, the collision prediction unit 150 predicts objects with intersecting predicted routes as objects that may collide. With such a configuration, the collision warning device 100 can also improve the accuracy of collision prediction.

As described above, the collision warning device 100 of the present example embodiment can improve the accuracy of object behavior prediction, and as a result, can also improve the accuracy of collision prediction. Therefore, the collision warning device 100 can enhance operational safety in the applied environment such as a warehouse or a factory.

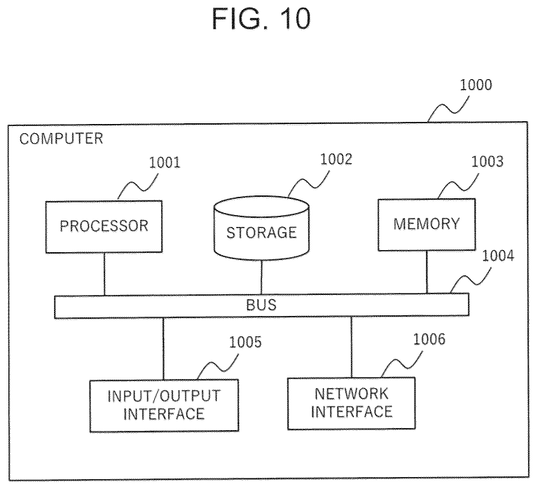

Next, the configuration of a computer according to the present disclosure will be explained. FIG. 10 is a block diagram illustrating a hardware configuration of a computer 1000 that enables the collision warning device 100. The computer 1000 is an arbitrary computer. For example, the computer 1000 may be a stationary computer such as a personal computer or a server machine. Alternatively, the computer 1000 may be a portable computer such as a smartphone or tablet device. The computer 1000 may be a dedicated computer designed to enable the collision warning device 100, or may be a general-purpose computer.

The computer 1000 includes a processor 1001, a storage 1002, a memory 1003, a bus 1004, an input/output interface 1005, and a network interface 1006.

The processor 1001 is various types of processing units such as a CPU (Central Processing Unit), GPU (Graphics Processing Unit), FPGA (Field-Programmable Gate Array), or DSP (Digital Signal Processor).

The storage 1002 is, for example, a non-transitory computer readable medium. The non-transitory computer readable medium includes various types of tangible storage media. Specific examples of the non-transitory computer readable medium include semiconductor memory such as mask ROM, PROM (Programmable ROM), EPROM (Erasable PROM), and flash ROM.

The memory 1003 is a main storage device implemented using, for example, RAM (Random Access Memory). The memory 1003 temporarily stores data when the processor 1001 executes processing.

The bus 1004 is a data transmission path for transmitting and receiving data among the processor 1001, the memory 1003, the storage 1002, the input/output interface 1005, and the network interface 1006. However, the method of connecting the processor 1001 and others is not limited to a bus connection.

The input/output interface 1005 is an interface for connecting the computer 1000 to input/output devices. For example, an input device such as a keyboard or an output device such as a display may be connected to the input/output interface 1005.

The network interface 1006 is an interface for connecting the computer 1000 to a network. The network may be a LAN (Local Area Network) or a WAN (Wide Area Network).

The storage 1002 stores a program for enabling each functional configuration unit of the collision warning device 100. The processor 1001 reads and executes this program in the memory 1003, thereby enabling each functional configuration unit of the collision warning device 100.

The collision warning device 100 may be enabled by a single computer 1000 or by a plurality of computers 1000. In the latter case, the configurations of the respective computers 1000 do not need to be the same and may differ.

Each functional configuration unit of the collision warning device 100 may be enabled by a combination of the above-described hardware and software, or may be enabled by hardware alone (for example, hard-wired electronic circuits).

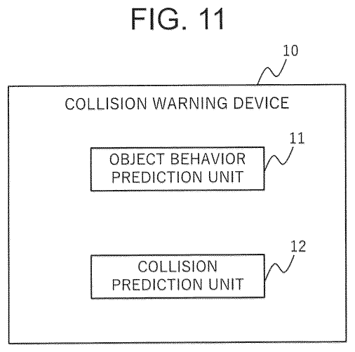

Next, an overview of the present disclosure will be explained. FIG. 11 is a block diagram illustrating a main part of the collision warning device. The collision warning device 10 shown in FIG. 11 (for example, corresponding to the collision warning device 100) includes an object behavior prediction unit 11 (in the example embodiment, implemented as the object behavior prediction unit 140) that predicts behavior of an object based on object behavior history information indicating a behavior history of the object detected from an input image and work instruction information indicating a work instruction related to the object, and a collision prediction unit 12 (in the example embodiment, implemented as the collision prediction unit 150) that predicts a collision between objects based on a behavior prediction result by the object behavior prediction unit 11 and outputs collision warning information based on a collision prediction result. With such a configuration, the collision warning device 10 can improve the accuracy of object behavior prediction and, as a result, can also improve the accuracy of collision prediction.

Although the present disclosure has been explained with reference to the example embodiment, the present disclosure is not limited to the above-described example embodiment. The configuration and details of the present disclosure may be variously modified within the scope of the present disclosure by those skilled in the art. Each example embodiment may be combined with other example embodiments as appropriate.

Each figure is merely an illustration for explaining one or more example embodiments. Each figure is not necessarily associated with only one specific example embodiment and may be associated with one or more other example embodiments. As will be understood by those skilled in the art, various features or steps described with reference to one figure may be combined with features or steps shown in one or more other figures to create an embodiment not explicitly illustrated or described. Not all of the features or steps shown in a figure for explaining an example embodiment are necessarily required, and some features or steps may be omitted. The order of the steps described in any figure may also be changed as appropriate.

Some or all of the above-described example embodiment may also be described as the following supplementary notes, but are not limited thereto.

### (Supplementary Note 1)

A collision warning device including:
object behavior prediction unit that predicts behavior of an object based on object behavior history information indicating a behavior history of the object detected from an input image and work instruction information indicating a work instruction related to the object; and
collision prediction unit that predicts a collision between objects based on a behavior prediction result by the object behavior prediction unit and outputs collision warning information based on a collision prediction result.

### (Supplementary Note 2)

The collision warning device according to Supplementary note 1, wherein
the work instruction information includes destination related information that enables identifying a destination of the object, and
the object behavior prediction unit predicts behavior of the object based on the object behavior history information and the destination related information.

### (Supplementary Note 3)

The collision warning device according to Supplementary note 1 or Supplementary note 2, wherein
the object behavior prediction unit predicts behavior of the object based on a predicted route of the object calculated from the object behavior history information and a positional relationship between a current position of the object and the destination.

### (Supplementary Note 4)

The collision warning device according to Supplementary note 3, wherein
the object behavior prediction unit calculates a curve connecting a start point and the destination based on a line segment defined by the start and end points of the predicted route of the object calculated from the object behavior history information and a line segment defined by the end point and the destination, and adopts the curve as a final predicted route.

### (Supplementary Note 5)

The collision warning device according to Supplementary note 4, wherein
when an obstacle exists between the start point of the predicted route of the object calculated from the object behavior history information and the destination of the object, the object behavior prediction unit calculates a curve connecting the start point and the destination in such a way as to avoid the obstacle and adopts the curve as a final predicted route.

### (Supplementary Note 6)

The collision warning device according to Supplementary note 4 or Supplementary note 5,
the collision prediction unit predicts objects with intersecting predicted routes as objects that may collide.

### (Supplementary Note 7)

The collision warning device according to any one of Supplementary notes 1 to 6, wherein
the collision prediction unit outputs the collision warning information to objects that may collide.

### (Supplementary Note 8)

The collision warning device according to any one of Supplementary notes 1 to 7, further including:
object detection unit that detects an object from an input image; and
object tracking unit that generates the object behavior history information based on an object detection result of one input image and an object detection result of an input image obtained before the one input image.

### (Supplementary Note 9)

A collision warning method performed by a computer and including:
predicting behavior of an object based on object behavior history information indicating a behavior history of the object detected from an input image and work instruction information indicating a work instruction related to the object; and
predicting a collision between objects based on a behavior prediction result and outputting collision warning information based on a collision prediction result.

### (Supplementary Note 10)

A collision warning program for causing a computer to execute:
an object behavior prediction process to predict behavior of an object based on object behavior history information indicating a behavior history of the object detected from an input image and work instruction information indicating a work instruction related to the object; and
a collision prediction process to predict a collision between objects based on a behavior prediction result by the object behavior prediction process and to output collision warning information based on a collision prediction result.

### (Supplementary Note 11)

A non-transitory computer readable medium storing a collision warning program executable by a computer to perform processing including:
predicting behavior of an object based on object behavior history information indicating a behavior history of the object detected from an input image and work instruction information indicating a work instruction related to the object; and
predicting a collision between objects based on a behavior prediction result and outputting collision warning information based on a collision prediction result.

Some or all of the elements (for example, configuration and function) described in Supplementary notes 2 to 8, which are dependent on Supplementary note 1, may also be dependent on Supplementary notes 9, 10 and 11 with the same dependency relationship as in Supplementary notes 2 to 8. Some or all of the elements described in any Supplementary note may be applied to various hardware, software, recording means for recording software, systems, and methods.

1. A collision warning device comprising:
a memory storing software instructions; and
one or more processors configured to execute the software instructions to:
predict behavior of an object based on object behavior history information indicating a behavior history of the object detected from an input image and work instruction information indicating a work instruction related to the object; and
predict a collision between objects based on a behavior prediction result and output collision warning information based on a collision prediction result.

2. The collision warning device according to claim 1, wherein
the work instruction information includes destination related information that enables identifying a destination of the object, and
the one or more processors are configured to execute the software instructions to predict behavior of the object based on the object behavior history information and the destination related information.

3. The collision warning device according to claim 2, wherein
the one or more processors are configured to execute the software instructions to predict behavior of the object based on a predicted route of the object calculated from the object behavior history information and a positional relationship between a current position of the object and the destination.

4. The collision warning device according to claim 3, wherein
the one or more processors are configured to execute the software instructions to calculate a curve connecting a start point and the destination based on a line segment defined by the start and end points of the predicted route of the object calculated from the object behavior history information and a line segment defined by the end point and the destination, and adopt the curve as a final predicted route.

5. The collision warning device according to claim 4, wherein
when an obstacle exists between the start point of the predicted route of the object calculated from the object behavior history information and the destination of the object, the one or more processors are configured to execute the software instructions to calculate a curve connecting the start point and the destination in such a way as to avoid the obstacle and adopts the curve as a final predicted route.

6. The collision warning device according to claim 4, wherein
the one or more processors are configured to execute the software instructions to predict objects with intersecting predicted routes as objects that may collide.

7. The collision warning device according to claim 1, wherein
the one or more processors are configured to execute the software instructions to output the collision warning information to objects that may collide.

8. The collision warning device according to claim 1, wherein the one or more processors are further configured to execute the software instructions to:
detect an object from an input image; and
generate the object behavior history information based on an object detection result of one input image and an object detection result of an input image obtained before the one input image.

9. A collision warning method performed by a computer and comprising:
predicting behavior of an object based on object behavior history information indicating a behavior history of the object detected from an input image and work instruction information indicating a work instruction related to the object; and
predicting a collision between objects based on a behavior prediction result and outputting collision warning information based on a collision prediction result.

10. A non-transitory computer readable medium storing a collision warning program executable by a computer to perform processing comprising:
predicting behavior of an object based on object behavior history information indicating a behavior history of the object detected from an input image and work instruction information indicating a work instruction related to the object; and
predicting a collision between objects based on a behavior prediction result and outputting collision warning information based on a collision prediction result.

11. The collision warning device according to claim 5, wherein
the one or more processors are configured to execute the software instructions to predict objects with intersecting predicted routes as objects that may collide.

12. The collision warning device according to claim 2, wherein
the one or more processors are configured to execute the software instructions to output the collision warning information to objects that may collide.

13. The collision warning device according to claim 3, wherein
the one or more processors are configured to execute the software instructions to output the collision warning information to objects that may collide.

14. The collision warning device according to claim 4, wherein
the one or more processors are configured to execute the software instructions to output the collision warning information to objects that may collide.

15. The collision warning device according to claim 5, wherein
the one or more processors are configured to execute the software instructions to output the collision warning information to objects that may collide.

16. The collision warning device according to claim 6, wherein
the one or more processors are configured to execute the software instructions to output the collision warning information to objects that may collide.

17. The collision warning device according to claim 11, wherein
the one or more processors output the collision warning information to objects that may collide.
